(19) United States
(12) Patent Application Publication
(10) Pub. No.: US 2012/0051349 A1
(43) Pub. Date: Mar. 1, 2012

(54) Base Station Caching for an Efficient Handover in a Mobile Telecommunication Network with Relays

(76) Inventors: Oumer Teyeb, Stockholm (SE); Simone Redana, Munich (DE); Vinh Van Phan, Oulu (FI); Bernhard Raaf, Neuried (DE); Min Huang, Beijing (CN); Richard Waldhauser, München (DE)

(21) Appl. No.: 13/263,420

(22) PCT Filed: Apr. 9, 2009
(86) PCT No.: PCT/EP2009/054305

§ 371 Date: Oct. 31, 2011

(51) Int. Cl. H04W 92/00

(52) U.S. Cl. 370/338

(57) ABSTRACT

It is described a method for transferring data in a downlink direction from a transmitting network element to a user equipment. The described method includes (a) sending at least one data packet from the transmitting network element to a source base station, (b) receiving the data packet by the source base station, which is connected to a source relay node representing a source access point for the user equipment, (c) caching the data packet by the source base station, (d) handing over the user equipment from the source relay node to a target access point, and (e) transferring the data packet from the source base station via the target access point to the user equipment. It is further described a corresponding method for transferring data in an uplink direction from a user equipment to a receiving network element, wherein the caching is carried out by a target base station. Furthermore, it is described a source base station and a target base station, which are adapted to carry out respectively one of the above mentioned data transferring methods.

### FIELD OF INVENTION

The present invention generally relates to the technical field of mobile telecommunication networks. In particular, the present invention relates to methods for transferring data within a relay enhanced mobile telecommunication network in connection with a handover of a user equipment, which is reconnected from a source access point to a target access point. Further, the present invention relates to a source base station and to a target base station, which are adapted to carry out respectively one of the above mentioned data transferring methods. Furthermore, there is described a computer program for carrying out at least one of the above mentioned data transferring methods.

### ART BACKGROUND

In order to allow for cost efficient and flexible deployment solutions, within the third generation partnership project (3GPP) relaying is investigated as one of the new technologies for Long Term Evolution (LTE) networks and in particular for Long Term Evolution Advanced (LTA-A) networks. It has been shown that with the usage of Relay Nodes (RN) the spatial coverage and/or the capacity of a base station (BS) can be significantly increased. Further, areas can be covered which without using RN would suffer from bad radio conditions. Such areas are located typically at the edge of a cell being served by a particular BS.

Apart from this main goal of coverage extension, introducing relay concepts can also help in (a) providing a high-bit-rate coverage in high shadowing environments, (b) reducing average radio-transmission power at a user equipment (UE), thereby leading to long battery life, (c) enhancing the cell capacity and effective throughput, e.g., increasing cell-edge capacity and balancing cell load and (d) enhancing the overall performance and deployment cost of a Radio Access Network (RAN).

Also the IEEE standardization bodies such as the IEEE 802.11 and IEEE 802.16 group notice and investigate the potential of relaying technology. In this respect it is mentioned that the specification IEEE 802.16 is influenced for instance by pre-standardization activities such as for instance Wireless World Initiative New Radio (WINNER) project (see http://www.ist-winner.org/), wherein investigations regarding RN are carried out. This means that telecommunication networks relying on RN are achieving the level of maturity that is needed in ongoing standardization activities. The best evidence of this maturity is the IEEE 802.16j standardization where RN are added on top of the IEEE 802.16e standard. This recent development has increased the pressure to consider RN also in LTE standardization.

There are many kinds of relay systems proposed starting from the simplest amplify/forward RN, which is applied e.g. in single frequency Digital Video Broadcasting-Handhelds (DVB-H) networks ending up to the most complex one, which utilizes a network coding to improve the overall performance. The most common type of RN that is proposed for use of RN in cellular networks (cellular relaying) is a detect/forward type of RN, where an input signal is detected and retransmitted using the same procedure as in the original transmission. Such an approach is assumed in this document.

Cellular relaying can be realized at the different layers of a protocol stack, which layers are described by the well known Open Systems Interconnection Reference Model (OSI model). A simple amplify and forward relaying can be realized at the Layer 1 of the protocol stack where the RN is required to have only (some part of) the PHY layer. Layer 2 RNs, which include the protocol stack up to the Media Access Control (MAC)/Radio Link Control (RLC) layers, enable the possibility of doing decentralized radio resource management. Layer 3 or higher layer RNs could almost be considered as wireless base stations and support all the protocol layers of normal base stations. Layer 3 or higher layer relaying is assumed in this document for the sake of simplicity in notations. However, the described handover procedure can easily be extended for layer 2 relays as well.

In order to make LTE-A economically viable, it is required to be as much backward compatible with 3GPP Release 8 as possible. This is especially important for the UE side, as it will allow users to benefit from relaying with their Release 8 terminals. Based on previous 3GPP experiences it is herein assumed that full backward compatibility is required from UE side, i.e. Release 8 and LTE-A UEs should work equally well in Release 8 and LTE-A networks. At the network side software and even hardware updates between standard releases may be possible but preferably they should be as small as possible. Hence, from the viewpoint of a UE the serving network node respectively the current access point should function in exactly the same way as a Release 8 BS, which is called enhanced NodeB (eNB). Due to this requirement the reduction of BS functionalities when defining a RN will be difficult and RNs need to support all main eNB functions of a BS respectively of an eNB. Due to this fact it is often assumed that RNs, which will be employed in future telecommunication networks, will be capable of flexible resource sharing with the eNB that controls them. Moreover, it is often assumed that (a) the telecommunication network will allow at maximum 2 hops (BS-UE and BS-RN-UE) and (b) the network topology has a tree design (no connections between different RNs are allowed), but again the described handover procedure also works in the general case without these restrictions, indeed it will be applicable to intermediate RNs as well.

In 3GPP Release 8, only hard handovers are supported, because the performance benefits of soft handovers are considered as to be not worth the complexity incurred in realizing them. This means that once a hard handover is started downlink data packets arriving to the serving BS have to be buffered and forwarded to the target BS until the handover procedure is complete. This is specified in the 3GPP Technical Specification (TS) 36.300 in the following way: (a) Upon handover, the source BS forwards to the target BS all downlink data packets (Packet Data Convergence Protocol (PDCP) Service Data Units (SDUs)) with their respective Sequence Number (SN) that have not been acknowledged by the UE. In addition, the source BS may forward without a PDCP SN fresh data to the target BS. (b) Upon handover, the source BS forwards uplink PDCP SDUs that are successfully received in-sequence to its serving gateway and may forward uplink PDCP SDUs with their SN received out-of-sequence to the target BS.

In the following it is considered a handover of a UE from a source RN via a source BS to a target BS or via a target BS to a target RN in an E-UTRAN system with relay extension. If the source RN is responsible for the PDCP layer functions in a similar way as specified in the current E-UTRAN for the BS, upon handover a certain amount of downlink PDCP SDUs with their SN, as described above, should be forwarded first from the source RN back to the source BS and then further to the target cell where the UE is handed over to. This amount of data thus has been transferred forth-and-back between the source RN and the source BS. This is a “redundant back-forwarding” from the source RN to the source BS and can cause a big overhead for radio transmissions of data packets. This holds in particular if a number of RNs are used in the respective cell of the telecommunication network and the handover frequency is high. However, a high number of RNs in a cell are beneficial, because then each RN can use low power transmission, but then the coverage area of each RN gets small and handover frequency gets high, as users move around.

For the uplink direction there exits an optional feature in the 3GPP standards, which is described in the Technical Specifications 3GPP TS 23.401, 3GPP TS 36.300, 3GPP TS 36.413 and 3GPP TS 36.423. This feature allows to forward data packets that where already received at the source BS, but that could not be sent to the serving gateway because the data packets have not been received by the source BS consecutively. This means that the sequence of data packets contains gaps for data packets that were not successfully received by the source BS. Normally the UE is obliged to resend all the uplink data packets beginning from the first PDCP SDU which had not been acknowledged by the source BS, i.e. both not acknowledged and acknowledged PDCP SDUs need to be resent by the UE at the target side after such a gap. A SN Status Transfer message informs the target BS about the first PDCP SN that is expected at the target side from the UE to be passed to the serving gateway. PDCP SDUs arriving from the UE having assigned a lower PDCP SN as the next expected shall be discarded by the target BS. This is because these PDCP SDUs may have already been received and forwarded by the source RN via the source BS to the target BS but the UE is not aware of it e.g. the acknowledgement may have been lost.

A further optional handover feature allows forwarding of out-of-sequence received data packets to the target BS. Additional optional information may be transferred by the afore mentioned SN Status Transfer message in the form of a bitmap. This bitmap, together with the information about the SN of the next expected uplink PDCP SDU, allows the target BS to identify the correct position that these forwarded uplink data packets shall be assigned by the target BS between the missing uplink data packets that are resent by the UE. Thus, it is possible to send a complete, in-sequence data packet stream from the target BS to the serving gateway, i.e. the data packet stream received at the serving gateway looks the same as for the case that no handover has been performed. Further control-plane communication between the target BS and the UE informs the UE about the uplink data packets that have been forwarded from the source BS to the target BS and thus need not be resent over the air-interface between the UE and the target BS.

However, if at the target side the UE will be connected not directly to the target BS but indirectly via a target RN to the target BS the above described optional features for an uplink data packet transfer in connection with a UE handover do not apply and, as in the above described known downlink scenario, a significant overhead and delay increase for radio transmitting data packets will occur.

There may be a need for reducing the radio overhead and delay in connection with carrying out handovers in a relay enhanced mobile telecommunication network.

### SUMMARY OF THE INVENTION

This need may be met by the subject matter according to the independent claims. Advantageous embodiments of the present invention are described by the dependent claims.

According to a first aspect of the invention there is provided a method for transferring data within a telecommunication network in a downlink direction from a transmitting network element to a user equipment. The described method comprises (a) sending at least one data packet from the transmitting network element to a source base station, (b) receiving the data packet by the source base station, which is connected to a source relay node representing a source access point for the user equipment, (c) caching the data packet by the source base station, (d) handing over the user equipment from the source relay node to a target access point, and (d) transferring the data packet from the source base station via the target access point to the user equipment.

The described method for transferring data in the downlink direction is based on the idea that by at least temporarily buffering the data packet in the source base station (BS) the need for resending the data packet between the source relay node (RN) and the source BS after a completion of the handover of the user equipment (UE) can be effectively eliminated. Thereby, the overall radio data traffic within the telecommunication network and in particular between the source RN and the source BS can be reduced significantly. Moreover, the delay for transmitting data traffic between the source RN and the source BS is avoided. This holds in particular if the UE is handed over frequently within the relay enhanced telecommunication network, wherein at least the source access point (AP) is a RN. At the same time the handover can be performed quicker because the time to resend the data packet between the source RN and the source BS is eliminated as well and consequently the user experience is enhanced.

The transmitting network element may be any network element, which is communicating with the UE. In particular, the transmitting network element may be a further UE which is connected to the UE. Thereby, the connection between the two UEs may be established via a core network such as for instance an IP based network. Thereby, the UE and/or the further UE may be connected to the core network via appropriate gateways.

The transmitting network element may also be any network element which is located in or along the network path extending between the UE and the further UE. In particular, the transmitting network element may be a gateway connecting the source base station and/or the target AP to the core network.

It is mentioned that for carrying out the described downlink data transfer method it may be assumed that the source RN is capable of accomplishing a flexible resource sharing with the source BS that controls it. Moreover, it may be assumed that (a) the telecommunication network will allow at maximum two hops (BS-UE and BS-RN-UE) and (b) the network topology has a tree design (no connections between different RNs are allowed). However, these two assumptions are only used to simplify the telecommunication network setting but it is emphasized that the described method can be extended to cover also other network topologies. For example, the mechanism presented in this document can be applied in the same way by using the so called S1 interface between the BS and a gateway connecting the BS to a core network instead of the so called X2 interface connecting different BSs with each other. This holds because for each X2-message respectively each data packet being transferred via the X2 interface there typically exists a corresponding S1-message respectively a corresponding data packet for the S1 interface. This might be necessary when e.g. no X2 interface exists, or when X2 supported handover is not allowed for some reason.

The source RN may communicate the need for starting the described caching to the source BS, if the described handover of the UE is expected in the near future. If the source RN represents a source AP for different UEs, the source RN may indicate to the source BS, for which particular UE a handover is expected such that the at least one data packet, which is intended for the particular UE, is buffered respectively cached by the source BS.

In this context the source RN may give an indication to the source BS for instance by transmitting an appropriate control message, that the source BS should start caching data packets being intended to be delivered at the UE. Further, the source RN may give to the source BS an indication how likely a handover (HO) of the UE from the source RN to the target access point is. Thereby, the source BS may be provided with enough information how to focus its limited radio resources on the right UE.

The term “caching the data packet” may mean in this document that the data packet is kept in a data storage unit in order to have the data packet quickly, readily and from a computational point of view cheaply available in case the data packet will be needed e.g. a second time by any entity within the telecommunication network. Thereby, caching may mean that the data packet is stored redundantly whereas the data packet is also available somewhere else such as for instance at the source RN.

According to an embodiment of the invention the target access point is a target relay node, which is connected to a target base station or to the source base station. This may mean that also on the target side the UE is connected via a target RN indirectly to a target BS or to the source BS. The latter means that the source base station, which according to the invention is capable of temporarily buffering or caching at least one data packet, can alternatively also act as a target base station.

If the target RN is connected to the target BS being different from the source BS, transferring the data packet from the source BS via the target AP to the UE comprises altogether three hops (source BS-target BS, target BS-target RN, and target RN-UE). Thereby at least two hops (target BS-target RN, target RN-UE) involve a radio data transfer. The data transfer from the source BS to the target BS may be realized for instance by employing the so called X2 interface.

If the target RN is connected to the source BS, which therefore also acts as a target BS, transferring the data packet from the source BS via the target AP to the UE comprises altogether two hops (source BS-target RN, target RN-UE), wherein both hops involve a radio data transfer.

According to a further embodiment of the invention the target access point is a target base station or the source base station. This may mean that on the target side there is no relaying and the UE is connected directly to a target BS or to the source BS. The latter means that the source base station, which according to the invention is capable of temporarily buffering the at least one data packet, acts also as a target base station.

According to a further embodiment of the invention the method further comprises selecting the at least one data packet from a plurality of data packets based on a Quality of Service (QoS) being assigned to the data packet. The QoS may be any value indicating the grade of a service the data packet is assigned to. In particular, the QoS may be (a) a time delay, (b) a minimum and/or a maximum data rate and/or (c) a requested and/or an actual reliability. The QoS may be associated with different types of bearers of the data packet.

According to another embodiment a data transfer between the source base station and the user equipment is confirmed by applying a hop by hop Automated Repeat Request (ARQ) procedure. This may mean that there is no end-to-end ARQ procedure between the source BS and the UE. By contrast to an end-to-end ARQ procedure, the described hop by hop ARQ procedure comprises separate ARQ sub-procedures (a) on the source BS to source RN and (b) on the source RN to UE radio links.

In this respect it is noted that if an end-to-end ARQ procedure would be employed between the source BS and the UE, the source BS would have an implicit caching. This would mean that data packets are not flushed from the source BS buffer until its proper reception at the UE is acknowledged and as such an explicit caching would not be necessary.

Furthermore, relying on an end-to-end ARQ procedure would anyhow have the disadvantage that bigger packets would have to be forwarded. For instance if the half number of data packets was already confirmed by an inner ARQ procedure, then this half number does not have to be sent again, in particular not on the link between the target access point and the already handed over UE and, if applicable, on the link between the source BS and the target BS.

According to a further embodiment of the invention caching the data packet by the source base station is only started if a predefined trigger criterion is met. The predefined trigger criterion may be indicative for an imminent handover. Further, the trigger criterion may be derived from a handover (HO) trigger criterion. For instance a similar criterion than for a handover criterion can be used, but different trigger values are used to start caching or to start the handover.

In particular, the predefined trigger criterion may be derived from a signal strength difference, which is given by (a) a source signal strength between the user equipment and the source relay node minus (b) a target signal strength between the user equipment and the target access point is smaller than a predefined first signal strength difference. Thereby, the signal strength difference can take positive or negative values.

Further, the predefined trigger criterion may be associated from another parameter such as for instance a Reference Signal Received Quality (RSRQ).

The described trigger respectively the described constraint for starting caching may provide the advantage that the caching is only carried out if there is at least a certain probability that the described handover of the UE between the source RN and the target AP will be carried out at least in the near future. Only in this case the at least one cached data packet will be used. If the handover is not expected the effort for carrying out the described caching can be avoided. A memory of the source BS can then be used for other purposes. In particular, the memory could be used for caching data packets which are assigned to another UE, which is currently being served by the source RN and which has a higher probability for being handed over from the source RN to the target AP or to another target AP.

The source signal strength and/or the target signal strength may be determined by the UE for instance by measuring the reference signal received power (RSRP) from the source RN (source signal strength) and the target AP (target signal strength). It is mentioned that of course also other measurements can be used in order to decide whether the handover of the UE from the source RN to the target AP is expected in the future.

The predefined signal strength difference may be called for instance a Caching Threshold (CT) for enabling caching.

The decision to start caching can either be made in the source base station or the source RN. In the latter case, it is sufficient that the source RN sends a request to start caching of the requested UE(s) data packet(s) to the source base station. It is then not necessary to send the individual measurements. In this case the BS can configure a parameter that determines how early to start caching. For example, the source BS can configure the CT in its subordinate RNs. The more memory there is available in the source BS for caching, the earlier caching can be started and the lower the CT can be set.

As a further embodiment, it may be possible that the RN sends some information to the source BS that is indicative about how likely a HO will happen in the near future. This may allow the source BS to enable caching for the UEs that will most likely be handed over. This is particularly relevant if different UEs are connected via different source RNs, then none of the RNs can decide which UEs are most important to cache data, only the source BS can combine the indications. However, it may not be necessary to send explicitly the underlying measurements like RSRP, but only a derived parameter being indicative for the HO probability in order to save signaling capacity on the radio link between the source RN and the source BS.

According to a further embodiment of the invention caching the data packet by the source base station is only started if the predefined trigger criterion is met for a predefined amount of time. This may provide the advantage that fluctuations of the value of the difference between the source signal strength and the target signal strength around a predefined signal strength difference will not initiate the described caching. Such fluctuation may occur for instance if the UE is located in between the source RN and the target AP and the radio conditions vary at least slightly.

The predefined amount of time may be called for instance Time to Cache (TTC) for enabling caching.

According to a further embodiment of the invention caching the data packet by the source base station is terminated at least temporarily if the trigger criterion is no more met. This may be the case for instance if the signal strength difference becomes larger than a predefined further signal strength difference. Thereby, the predefined further signal strength difference may be larger than the afore mentioned predefined signal strength difference. Thereby, a hysteresis behavior may be achieved, which effectively prevents that due to signal strength fluctuation the process of caching is repeatedly started and finished.

Generally speaking, caching may be ended, if the trigger criterion is no more met at least for a certain measurement value difference and/or at least for a certain amount of time. Specifically, the caching may be ended if the signal strength difference is larger than this predefined further signal strength difference representing a threshold value for terminating the caching procedure, i.e. if it looks like that no handover will be needed despite the UE coming close to the target AP. This means that the caching procedure may not only be ended by a handover completion. Similarly as for starting caching, also for ending caching further criteria other than signal strength, and correspondingly adjusted thresholds can be used, similarly as explained above for starting caching.

According to a further embodiment of the invention a plurality of data packets are cached by the source base station and the source base station carries out a flow control for caching the plurality of data packets.

The described usage of a flow control may represent a very easy way to deal with the matter that the storage capacity of the source BS is limited. Thereby, an ordinary flow control may be employed, wherein a maximum cache size is configured. When the cache size limit is reached, data packets at the front of the cache may be dropped and new data packets can be inserted at the end side of the cache.

The described flow control can also include setting a time limit on each data packet that is being cached. This may provide the advantage that the source BS can estimate the time required for the data packet to arrive at the UE (plus some time margin if applicable) based on the properties of the bearer that is being used for the transfer of the respective data packet, i.e. the time limit may be different for different packets and may depend on the bearer the packet is assigned to.

The described flow control can be realized in different ways. There may be two important considerations in order to decide for an effectively working data packet caching. According to a first consideration it should be answered how many data packets could be cached. According to a second consideration it should be answered what is the maximum lifespan of a data packet in the cache. In the following there will be described four different preferred solutions Sol_{—}1, Sol_{—}2, Sol_{—}3 and Sol_{—}4 for realizing the cache flow control:

Sol_{—}1: The source RN can piggyback the status of the ARQ state in the radio link extending between the source RN and the UE, when the source RN sends a positive or a negative Acknowledgement (ACK) message for the ARQ procedure in the radio link between the source BS and the source RN. This can be considered as an ARQ “tunneling” where the ACK messages in the link between source RN and UE are tunneled towards the source BS representing the mother BS. For example if data packets up to the SN G have been properly received by the UE, and the source RN just receives the data packet J from the BS, the source RN may acknowledge this situation by sending a message like “ACK J, DEL G” instead of just “ACK J”. The source BS then knows that it can safely delete from its cache the data packet G and all the data packets which have been cached before the data packet G. This is a cumulative approach for acknowledging data packets.

It is mentioned that also a selective approach, similar to the known Transfer Control Protocol Selective Acknowledgement (TCP SACK) can be applied, which is described for instance in the publication “TCP Selective Acknowledgment Options by M. Mathis, J. Mandavi, S. Floyd and A. Romanow, Network Working Group, Request for Comments: 2018, Category Standard Track, October 1996”. Such a selective acknowledgement message(s) would be for example, ACK L, DEL G, DEL K, etc.

It is mentioned that also other approaches commonly used in acknowledging data packets can also be used to remove data packets from the cache. It should be noted that since the data packets in BS-RN link and in the RN-UE link are possibly not mapped one by one, the piggybacked acknowledgement in BS-RN link may come from the results of several data packets in RN-UE link, and may also refer to more than one data packet in the BS-RN link. However, in some scenarios when the data packets in BS-RN link and RN-UE link are mapped in pair, the ACK message can be replaced by a DEL message. This can help to decrease the signaling overhead of ARQ messages. In this respect it is mentioned that a similar approach but applied on PDCP level using PDCP status report instead of RLC status report may be adopted as well.

Sol_{—}2: Another way of realizing this flow control is by using implicit signaling between the source RN and the source BS. When a data packet's caching time limit expires, the data packet will be implicitly dropped unless an explicit signal is received from the source RN indicating that there has been some delay in the data packet forwarding (for example due to a bad radio link between the source RN and the UE). In addition, such an explicit signaling can be transferred periodically, i.e., a timer can be defined that upon its expiry, an explicit signaling is sent from the source RN to the source BS indicating the sequence number (e.g., PDCP SN) of those data packets that have been received successfully by the UE.

Sol_{—}3: The caching can also be done in a less optimal way. Depending on the available storage capacity in the source BS and when a handover is initiated, the source RN tells the source BS which data packets it still has in its buffer and, if those are not available in the cache of the source BS, the source RN is requested to forward them. Otherwise, the source RN does not have to forward anything.

Sol_{—}4: If only in-sequence delivery is assumed, the method described in the above mentioned publication “TCP Selective Acknowledgment Options by M. Mathis, J. Mandavi, S. Floyd and A. Romanow, Network Working Group, Request for Comments: 2018, Category Standard Track, October 1996” can possibly be further optimized where the source RN can start forwarding data packets to the source BS, starting from the oldest one. The source BS will stop this forwarding when it receives the first data packet that it has in its cache or when it receives the last data packet that it does no longer have in its cache. Alternatively the source BS can tell the source RN which data packets it has, then the source RN can immediately delete those data packets and only forward the missing data packets that are no more stored in the source BS.

In a further embodiment, the HO may be delayed after starting caching, until all data packets that have not been cached at the source BS have been transferred from the source RN to the UE. In this way any back-forwarding of in-transit data packets from the source RN to the source BS can be avoided. Apparently delaying the HO may not be desirable in case the HO is needed quickly, but it is applicable in case the UE does not move too quickly. Furthermore, there may be already a flow control implemented that ensures that the number of data packets in transit at the source RN is kept under control and not getting excessively large. Then the HO will not be delayed excessively either.

According to a further aspect of the invention there is provided a method for transferring data within a telecommunication network in an uplink direction from a user equipment to a receiving network element. The provided method comprises (a) sending at least one data packet from the user equipment to a source access point, (b) handing over the user equipment (UE) from the source access point to a target relay node representing a target access point for the user equipment and being connected to a target base station, (c) receiving the at least one data packet by the target base station, (d) caching the received data packet by the target base station, and (e) transferring the cached data packet from the target base station to the receiving network element.

The described method for transferring data in the uplink direction is based on the idea that by at least temporarily buffering the data packet in the target base station (BS) the need for resending the data packet between the target relay node (RN) and the target BS after a completion of the handover of the user equipment (UE) can be effectively avoided. Thereby, the overall radio data traffic within the telecommunication network in particular (a) between the target BS and the target RN as well as (b) between the target RN and the target BS can be reduced significantly. This holds in particular if the UE is handed over frequently within the relay enhanced telecommunication network, wherein the target access point (AP) is a RN.

In other words, the described caching of forwarded data packets for the UL direction at the target BS for the purpose of not transferring these packets in the case of a handover of the UE to the target RN may provide the advantage that significant capacity on the wireless relay link can be saved. Similarly a delay is avoided that would result from transferring the data packets.

The transmitting network element may be any network element, which is communicating with the UE. In particular, the transmitting network element may by a further UE which is connected to the UE. Thereby, the connection between the two UEs may be established via a core network such as for instance an IP based network. Thereby, the UE and/or the further UE may be connected to the core network via appropriate gateways. The transmitting network element may also be any network element which is located in or along the network path extending between the UE and the further UE. In particular, the transmitting network element may be a gateway connecting the source AP and/or the target BS to the core network.

As has already been mentioned above in connection with the method for transferring data in the downlink direction, for carrying out the described method it may be assumed that the RN (here the target RN) is capable of accomplishing a flexible resource sharing with the BS (here the target BS) that controls it. Moreover, it may be assumed that (a) the telecommunication network will allow at maximum 2 hops (BS-UE and BS-RN-UE) and (b) the network topology has a tree design (i.e. no direct connections between different RNs are allowed). However, these two assumptions are only used to simplify the telecommunication network setting but it is emphasized that the described method may be extended to cover also other network topologies. For example, the mechanism presented in this document can be applied in the same way by using the so called S1 interface between the BS and a gateway connecting the BS to a core network instead of the so called X2 interface connecting different BSs with each other. This holds because for each X2-message respectively each data packet being transferred via the X2 interface there typically exists a corresponding S1-message respectively a corresponding data packet for the S1 interface. This might be necessary when e.g. no X2 interface exists, or when X2 supported handover is not allowed for some reason.

According to the described method for transferring data in the uplink direction the information which may be contained in a SN Status Transfer message can be sent also to the target RN, e.g. by a message SN Status Transfer. Basically the target RN performs the function of a BS, but the target RN is not directly connected to the core network. The target RN is connected to the core network only indirectly via its target BS representing the mother BS.

It is mentioned that the functionality required to perform the handover of the UE will also be required at the respective target RN. This means that corresponding control information and forwarded packets will have to be forwarded from target BS to the target RN.

According to an embodiment of the invention the source access point is a source relay node, which is connected to a source base station or to the target base station. This may mean that also on the source side the UE is connected via a source RN indirectly to a source BS or to the target BS. The latter means that the target base station, which according to the invention is capable of temporarily buffering the at least one data packet, acts also as a source base station.

If the source RN is connected to the source BS being different from the target BS, receiving the at least one data packet, which has been transmitted from the user equipment towards the receiving network element, by a target base station comprises altogether three hops (UE-source RN, source RN-source BS, source BS-target BS). Thereby at least two hops (UE-source RN, source RN-source BS) involve a radio data transfer. The data transfer from the source BS to the target BS may be realized for instance by employing the so called X2 interface.

If the source RN is connected to the target BS, which therefore also acts as a source BS, transferring the data packet from the UE to the target BS comprises altogether two hops (UE-source RN, source RN-target BS), wherein both hops involve a radio data transfer.

According to a further embodiment of the invention the source access point is a source base station or the target base station. This may mean that on the source side there is no relaying and the UE is connected directly to a source BS or to the target BS. The latter means that the target base station, which according to the invention is capable of temporarily buffering the at least one data packet, acts also as a source base station.

According to a further embodiment of the invention the method further comprises combining at the target base station the at least one data packet, which has been received by the target base station via the source base station from the user equipment before the handover of the user equipment and which has been cached by the target base station with at least a further data packet, which has been received by the target base station via the target relay node after the handover. Thereby, transferring the data packet from the target base station to the receiving network element comprises transferring the combined data packets from the target base station to the receiving network element.

As has already been mentioned above the cache in the target BS is used to store the data packets destined for the UL direction that are received from the source AP rather than sending these data packets to the target RN and later receiving these data packets from the target RN. Using the information that has been received by the target BS by a message “SN Status Transfer”, this enables the target BS to insert these data packets at the right position when the missing packets are received from the UE via the target RN after the handover has been accomplished. This may provide the advantage to save the data packet transfer of the forwarded uplink data packets over the radio link between the target RN and the target BS. These data packets would otherwise have to be sent twice over this relay link. First from target BS to the target RN in order to enable the target RN to insert these packets at their right position for the uplink data stream and then again back from target RN to target BS as a member of the uplink data packet stream that can be sent to the receiving network element by the target BS.

A further advantage of the described method is that it will also reduce the delay that is caused by the handover, because data packets can be sent to the receiving network element more early because no time is lost for sending the data packets twice over the relay link extending between the target BS and the target RN.

It has to be mentioned that between the above described method for transferring data within a relay enhanced telecommunication network in a downlink direction and the method for transferring data within a relay enhanced telecommunication network in an uplink direction there exists a symmetry with respect to the capability of a mother BS (which is a source BS or target BS for the downlink respectively uplink scenario) being able to at least temporarily buffer data packets, which may or which may not have been delivered at a receiving network entity, which is arranged at a target network path. Thereby, the target network path connects the sender of the data packet and the receiver of the data packet after the handover of the UE has been completed. In the downlink scenario the receiving network entity is the UE and the mother BS is the source BS. In the uplink scenario the receiving network entity is the receiving network element mentioned above and the mother BS is the target BS. Due to the technical symmetry between the downlink data transferring method and the uplink data transfer method the features, which have been described in connection with the downlink data transferring method also apply for the uplink data transferring method in a corresponding manner and vice versa. This holds not only for the general description above but also for the specific description of preferred embodiments, which will be described further below in connection with the accompanying drawing.

According to a further aspect of the invention there is provided a source network element from the set of a source base station and a source relay node, which in co-operation with at least the other source network element from that set and a user equipment is adapted to carry out the above described method for transferring data within a telecommunication network in a downlink direction from a transmitting network element to the user equipment.

The described source network element is based on the idea that by at least temporarily buffering the data packet in the source base station the need for resending the data packet between the source RN and the source BS after a completion of the handover of the UE can be effectively avoided. Thereby, the overall radio data traffic within the telecommunication network and in particular between the source RN and the source BS can be reduced significantly with a consequently reduction of delay.

According to a further aspect of the invention there is provided a target side network element from the set of a target base station and a target relay node, which in co-operation with at least the other target network element from that set and a user equipment is adapted to carry out the above described method for transferring data within a telecommunication network in an uplink direction from the user equipment to a receiving network element.

The described target network element is based on the idea that by at least temporarily buffering the data packet in the target BS the need for resending the data packet between the target RN and the target BS after a completion of the handover of the UE can be effectively avoided. Thereby, the overall radio data traffic within the telecommunication network in particular (a) between the target BS and the target RN as well as in the opposite direction (b) between the target RN and the target BS can be reduced significantly with a consequently reduction of delay.

According to a further aspect of the invention there is provided a computer program for transferring data within a telecommunication network. The computer program, when being executed by a data processor of a network element, is adapted for controlling (a) the above described method for transferring data within the telecommunication network in a downlink direction from a transmitting network element to a user equipment or (b) the above described method for transferring data within the telecommunication network in an uplink direction from a user equipment to a receiving network element. Thereby, the network element may be in particular a source base station in the downlink scenario and a target base station in the uplink scenario.

As used herein, reference to a computer program is intended to be equivalent to a reference to a program element and/or to a computer readable medium containing instructions for controlling a computer system to coordinate the performance of at least one the above described methods.

The computer program may be implemented as computer readable instruction code in any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The computer program may be available from a network, such as the World Wide Web, from which it may be downloaded.

The invention may be realized by means of a computer program respectively software. However, the invention may also be realized by means of one or more specific electronic circuits respectively hardware. Furthermore, the invention may also be realized in a hybrid form, i.e. in a combination of software modules and hardware modules.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered as to be disclosed with this application.

The aspects defined above and further aspects of the present invention are apparent from the examples of embodiments to be described hereinafter and are explained with reference to the examples of embodiments. The invention will be described in more detail hereinafter with reference to examples of embodiments but to which the invention is not limited.

### BRIEF DESCRIPTION OF THE DRAWINGS

FIG. 1a shows a downlink data transfer to a user equipment, which is handed over from a source relay node to a target relay node, whereas both relay nodes are served by the same base station.

FIG. 1b shows a downlink data transfer to a user equipment, which is handed over from a source relay node being served by a source base station to a target relay node being served by a target base station.

FIGS. 2a, 2b, 2c and 2d show different handover scenarios according to embodiments of the invention, wherein data packets are transferred in the downlink direction from a transmitting network element to a user equipment.

FIGS. 3a, 3b, 3c and 3d show different handover scenarios according to embodiments of the invention, wherein data packets are transferred in the uplink direction from a user equipment to a receiving network element.

FIG. 4 shows an illustration of thresholds for buffering/caching data packets in connection with a possible handover of a user equipment.

FIG. 5 shows an exemplary realization of a handover in a relay enhanced LTE telecommunication network with a base station caching support.

### DETAILED DESCRIPTION

The illustration in the drawing is schematically. It is noted that in different figures, similar or identical elements are provided with the same reference signs.

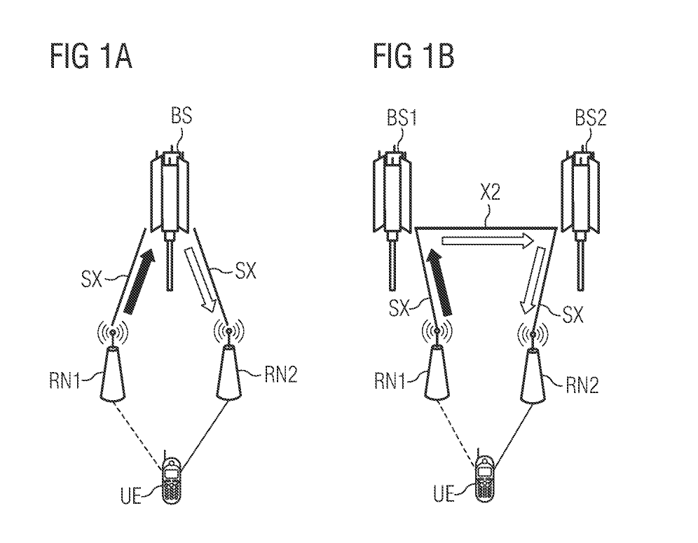

Since Long Term Evolution Advanced (LTE-A) is supposed to be implemented in a backward compatible fashion to 3GPP Release 8, it is expected that LTE-A will also support only a hard handover (HO). In a relay enhanced LTE-A telecommunication network, when a user equipment (UE) is handed over from one relay node (RN) to another RN, the buffered data in the source RN that has yet to be delivered to the UE has to be forwarded towards the target RN, possibly via another base station (BS) if the source RN and target RN are controlled by different BSs. This situation is illustrated in FIGS. 1a and 1b, where the data forwarding path is shown in block arrows. In FIG. 1a the data forwarding paths are shown for a handover between a source RN RN1 and a target RN RN2 both belonging to the same cell of the LTE telecommunication network, which cell is served by a base station BS. In FIG. 1b the data forwarding paths are shown for a handover between a source RN RN1 and a target RN RN2, which are assigned to different cells of the LTE telecommunication network. Thereby, the source RN RN1 is served by a source BS BS1 and the target RN RN2 is served by a target BS BS2.

Though the data transfer marked in the open bold arrows are unavoidable, as the target RN has to get the data while the UE is being handed over, the full bold arrow respectively indicates the sending of data packets that were at the source BS (BS or BS1) a few moments ago and that have been forwarded before to the source RN RN1. This “redundant” retransmission or “back-forwarding” can cause a big overhead. This holds in particular if there are several RNs in each cell and the handover frequency is high. This is a realistic scenario and it is also reflected in the 3GPP assumptions on relaying given in the technical report TR36.814 V0.0.0.

Apart from the increase in traffic on the relay link extending between the source RN RN1 and its mother BS (BS in FIG. 1a and BS1 in FIG. 1b), the additional forwarding will also increase the delay experienced by the data packets during handover. This delay increase with respect to the data packets being forwarded to the target RN RN2 might also increase the probability of out of order packet reception at the target RN RN2, because the new data packets that are being sent out to the new target RN RN2 might arrive before the older packets that are being forwarded from the old source RN RN1. It is also noted that data packets forwarded back from the source RN RN2 to its mother BS (BS or BS1) experience a transmission error probability on the wireless medium, which make the above mentioned problems even more relevant.

In FIG. 1a the interface between the base station BS on the one hand and the source relay node RN1 or the target relay node RN2 on the other hand is denominated with SX. This abbreviation reflects a combination between the known interfaces S1 and X2. In FIG. 1b the interface between the base stations BS1 or BS2 and the relay nodes RN1 or RN2, respectively, is denominated with SX. The interface between the two base stations BS1 and BS2 is denominated with X2, because according to the embodiment described here the BS1 and BS2 are connected via a standard X2 interface. The described handover is however also applicable, if the source and target base stations BS1 and BS2 are indirectly connected via the S1 interface to the gateway because for each X2-message there is a corresponding S1-message.

According to embodiments of the invention described hereinafter a method for decreasing the forwarding overhead and the data packet delay experienced during handover in relay enhanced LTE is described. The basic principle, which allows for realizing this decrease of the forwarding overhead and the data packet delay applies both to the downlink scenario and to the uplink scenario. In the following, still with reference to FIG. 1a and FIG. 1b, the downlink scenario is explained.

In the downlink scenario this basic principle is to enable a data packet caching at the source BS for the data packets that are being forwarded to the UE via the source RN RN1. In the case of handover of the UE from the source RN RN1 to the target RN RN2, the data packets can be forwarded from the source BS (BS or BS1) to the target side without the need to back-forward the data packets back from the source RN RN1 to the source BS (BS or BS1). Thereby, the data back-forwarding paths shown in FIGS. 1a and 1b with the full bold arrows can be eliminated.

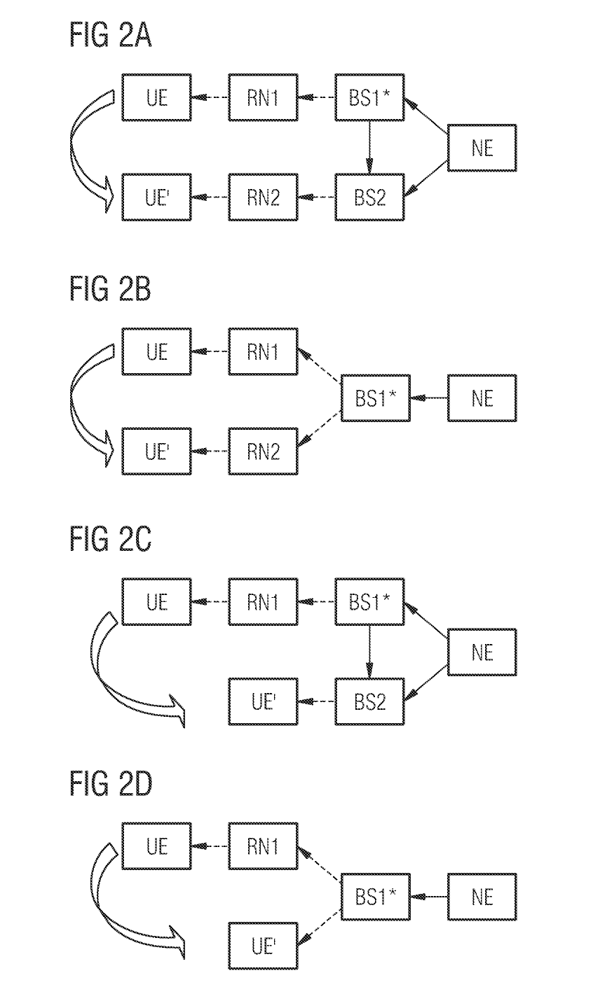

FIGS. 2a, 2b, 2c and 2d show different handover scenarios according to embodiments of the invention, wherein data packets are transferred in the downlink (DL) direction from a transmitting network element NE to a user equipment UE. Thereby, the user equipment before the handover is labeled with UE. The user equipment after the handover is denominated with UE′. The source BS BS1 is labeled with a star, which reflects the capability for caching data packets.

In the embodiment shown in FIG. 2a, the user equipment UE is handed over from a source RN RN1 to a target RN RN2. Thereby, both RNs are connected to different BSs, i.e. a source BS BS1* and a target BS BS2.

In the embodiment shown in FIG. 2b, the user equipment UE is handed over from a source RN RN1 to a target RN RN2. Thereby, both RNs are connected to the same BS, which is denominated with BS1*.

In the embodiment shown in FIG. 2c, the user equipment UE is handed over from a source RN RN1 directly to a target BS BS2. Thereby, the source RN is connected to a different BS, i.e. a source BS BS1*.

In the embodiment shown in FIG. 2d, the user equipment UE is handed over from a source RN RN1 to the source BS BS1*. Thereby, the source RN is connected to the same BS, i.e. the source BS BS1*.

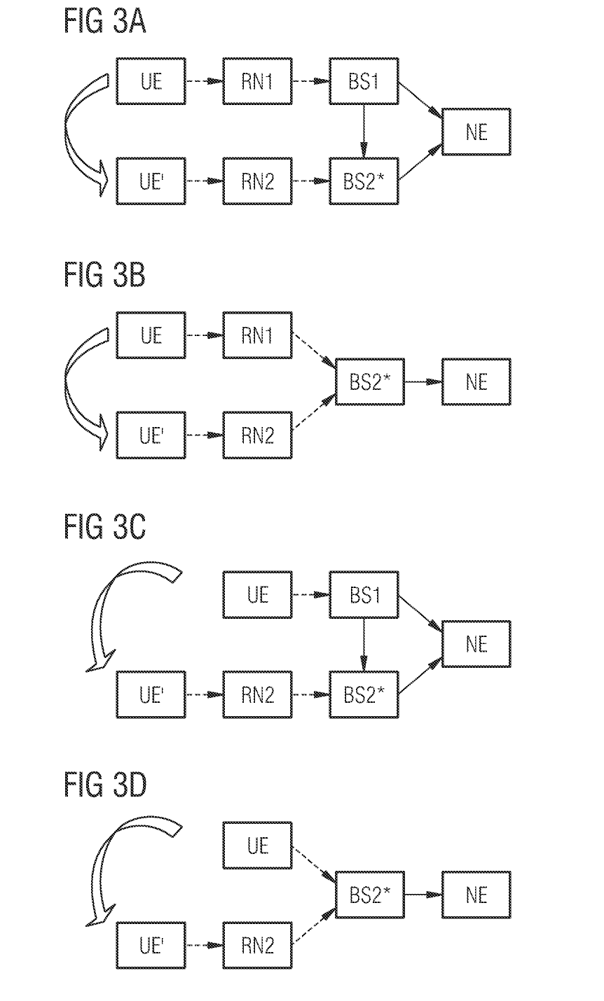

FIGS. 3a, 3b, 3c and 3d show different handover scenarios according to embodiments of the invention, wherein data packets are transferred in the uplink direction from a user equipment to a receiving network element. Again, the user equipment before the handover is labeled with UE. The user equipment after the handover is denominated with UE′. The target BS BS2 is labeled with a star, which reflects the capability for caching data packets.

In the embodiment shown in FIG. 3a, the user equipment UE is handed over from a source RN RN1 to a target RN RN2. Thereby, both RNs are connected to different BSs, i.e. a source BS BS1 and a target BS BS2.

In the embodiment shown in FIG. 3b, the user equipment UE is handed over from a source RN RN1 to a target RN RN2. Thereby, both RNs are connected to the same BS, which is denominated with BS2*.

In the embodiment shown in FIG. 3c, the user equipment UE is handed over from a source BS BS1 to a target RN, which is connected to a target BS2*.

In the embodiment shown in FIG. 3d, the user equipment UE is handed over from a BS representing both the source BS and the target BS BS2* to a target RN RN2 being connected to the only BS.

In the following and for the rest of this description the downlink scenario in case of a UE handover between two RNs is considered, which are controlled by two different BSs (as shown in FIGS. 1b and 2a). This is the most complex case and a person skilled in the art will be able to adapt the handover procedure also to the other handover scenarios. Specifically, the simpler case where both RNs are attached to the same BS works accordingly. Also the case where the handover is accomplished from a RN to a BS (including the source BS itself) works similarly, as the need to back-forward data packets from the source RN to the source BS is eliminated.

According to the embodiments described here and in accordance with LTE 3GPP Release 8, the Reference Signal Received Power (RSRP) is used for deciding whether a handover of the UE has to be carried out. Specifically, the RSRP is used in deciding to include the target RN (or generally the target access point) to the handover candidate set list comprising possible target access points. Furthermore, the handover process is initiated when the RSRP of the target RN exceeds the RSRP of the source RN for a given period of time. This is known as Time to Trigger (TTT).

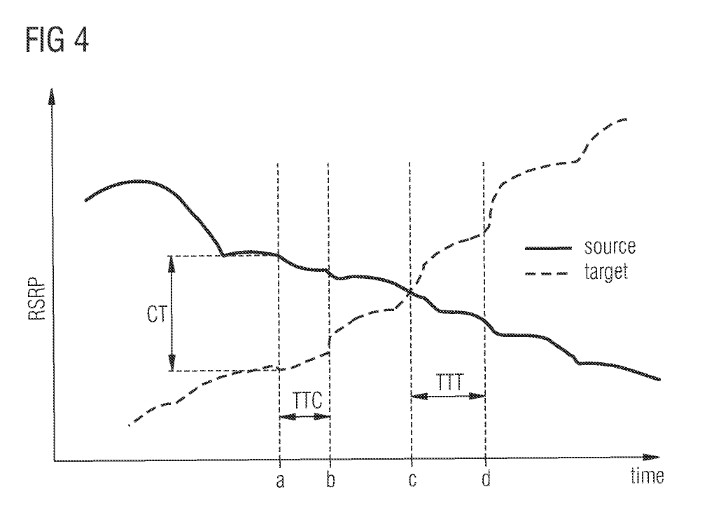

In the embodiment of the invention described here two additional thresholds are introduced, which are referred to as Time to Cache (TTC) and Caching Threshold (CT) both for enabling caching. The use of these thresholds is explained with reference to FIG. 4. Although in this FIG. 4 RSRP measurements are used, the described data transferring method during the handover can be generalized also to other types of measurements.

When the RSRP of a target RN is within the CT (source RN RSRP−target RN RSRP<CT) as in time point “a” and it stays so for the duration of TTC (at time point “b”), the source BS starts caching the data that it is sending out to the source RN. The source RN communicates this need for caching to its mother BS (i.e. the source BS), indicating for which UE(s) data packets need to be cached, based on measurements on RN-UE links. The known time interval TTT extends between the time point “c” and the time point “d”.

When the source RN forwards the handover initiation message to the source BS, it includes information regarding the last data packet that it has properly forwarded to the UE. From this information, the source BS will be able to find the subset of its cache that has not reached the UE, and it forwards these data packets to the target RN via the target BS. Henceforth, all data packets arriving at the source BS, during the handover time, and which are destined for the UE that is being handed over are also forwarded to the target RN via the target BS.

It is mentioned that the caching procedure may be ended, if the RSRP difference is above a threshold, i.e. if it looks like no handover will be needed despite the UE coming close to the new RN. This threshold may be larger than CT and a time interval can be assumed when the RSRP difference is above the threshold and before the caching is ended. So caching may not only be ended by a successful completion of a handover.

In order to achieve an effective working caching there may be two important questions to be answered:

1) How many data packets could be cached?

2) What is the (maximum) lifespan of a packet in the cache?

The easiest way to solve the problem of the cache size is use an ordinary flow control, i.e. fix a maximum cache size, and when the cache size limit is reached, drop data packets at the front of the cache and insert new data packets at the end. A time limit can also be set on each data packet that is being cached, as the caching BS can estimate the time required for the data packet to arrive at the UE based on the properties of the bearer that is being used for the data packet transfer. E. g. high quality bearer data will be transferred with higher priority compared to low quality bearers, therefore the required time will be smaller for high quality bearers compared to low quality bearers.

There are several possibilities for complementing such a flow control. Four of such possibilities Sol_{—}1, Sol_{—}2, Sol_{—}3 and Sol_{—}4 have already been described above and for the sake of conciseness will not be repeated here.

It is mentioned that in the description of this invention so far, it was assumed that the RSRP is used as a measure to decide the handover and also to decide when to start caching data packets because a handover may be approaching. Obviously, also other parameters can be used as well and also more advanced averaging and trigger algorithms may be applied. Also in the most general case, different measurements can be used to decide whether to start caching and whether to initiate a handover.

For instance caching data packets can also be started depending on the available memory in the BS. For example, if the available memory supports to cache the data for 4 UEs, then the 4 UEs that are expected to be handed over at the earliest are selected, no matter how close they are to be handed over.

The 4 UEs can e.g. be selected as the 4 UEs for which the RSRP is closest to the trigger criterion (even if the criterion has not been reached) or, in the case that more than 4 UEs have already reached the criterion, the 4 UEs where the criterion has been exceeded most. Similarly, the 4 UEs can be selected based on the time since the criterion has been met or a combination of these approaches. Further, the 4 UEs can also be selected according to quality of service, e.g. it is better to cache a UE with high quality even if the criterion has been exceeded less than another UE with low quality.

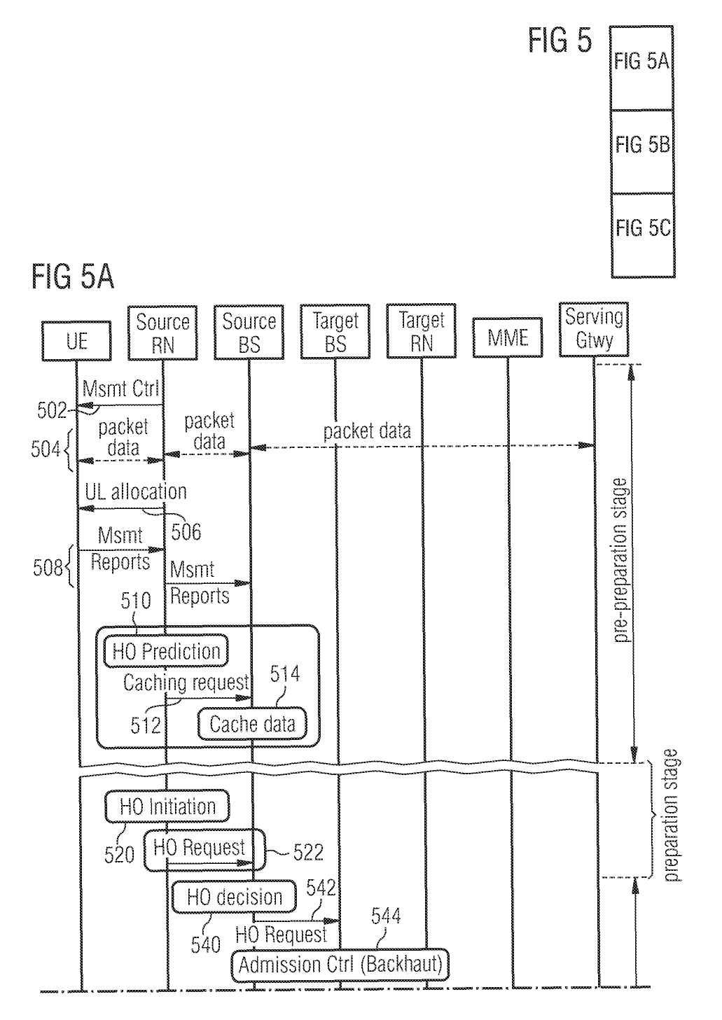

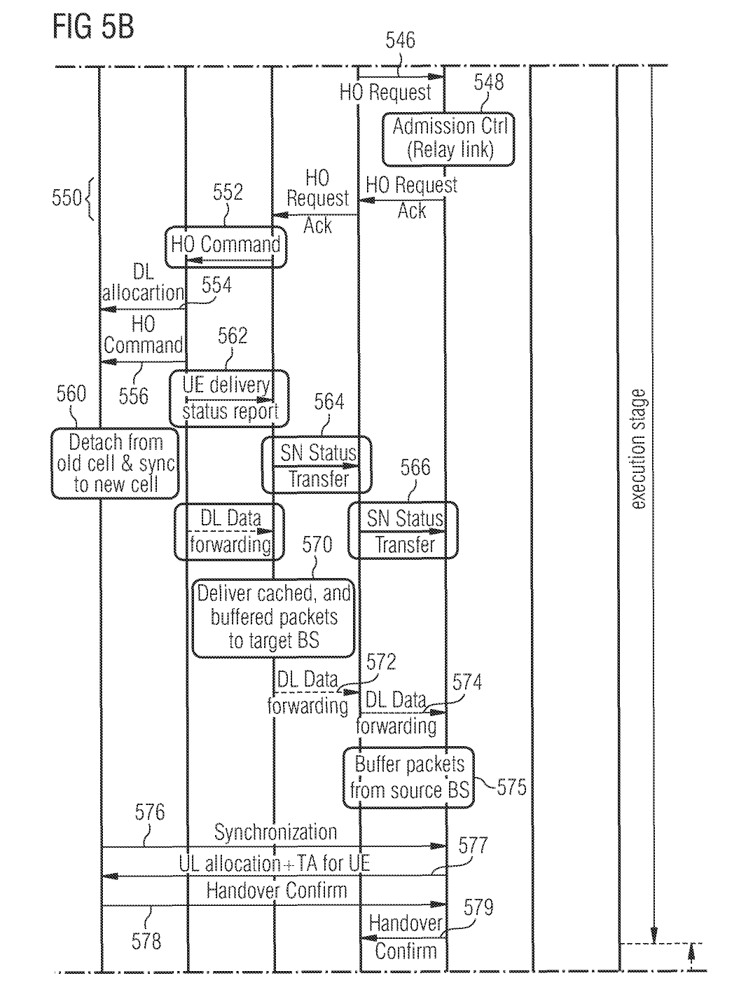

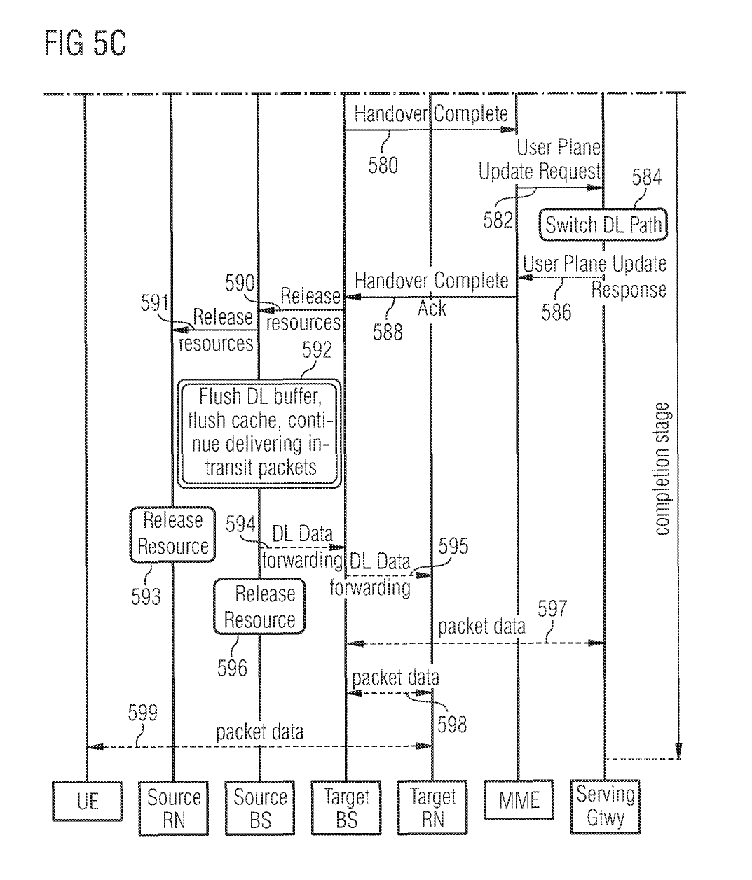

FIG. 5 shows an exemplary realization of a handover within a relay enhanced LTE telecommunication network with a BS caching support. In FIG. 5 full arrows indicate a transfer of signaling information between the network elements being connected by the respective full arrow. Thereby, the signaling may be realized on layer 1, layer 2 or on layer 3 of the Open Systems Interconnection Reference Model (OSI model). The dashed arrows in FIG. 5 indicate a data packet transfer between the network elements being connected by the respective dashed arrow.

Although the described handover procedure is presented using LTE (E-UTRAN) as a basis, it could be applicable to any other wireless mobile communication networks as well. The telecommunication network may have a fixed infrastructure providing wireless services to subscriber terminals. FIG. 5 illustrates the processes that may occur in a handover procedure in the communication network with the relay extension. The handover procedure may assign a UE from a source cell to a target cell. The source cell may apply other radio access networks than the target cell. For example, the source cell may operate under UMTS and the target cell may apply LTE or GSM, etc. The source cell and the target cell may comprise a base station such as for instance, an evolved node B as in E-UTRAN, a radio network controller (RNC) or any other network element capable of controlling a radio communication within the respective cell. The base station (BS) of the source cell is called source BS. The BS of the target cell is called target BS. Furthermore, the cell may comprise one relay node (RN) or more RNs. Correspondingly, the RN of the source cell is called source RN and the RN of the target cell is called target RN.

Although the description regarding to FIG. 5 is given for a telecommunication network where the handover occurs between two RNs that belong to different cells (the source cell and the target cell) served by different BSs, a person skilled in the art will readily acknowledge and understand, that the exemplary embodiment can be applied with minor and obvious changes to a telecommunication network where the handover occurs between a BS and a RN within the same cell (see FIGS. 2d and 3d), between a BS and a RN in an adjacent cell (see FIGS. 2a, 2c, 3a, 3c) or between two RNs within the same cell (see FIGS. 2b, 3b). Thus, the scope of the invention is not limited to a case where there are RNs at both the source cell and the target cell of the handover.

The handover procedure illustrated in FIG. 5 may be subdivided into four stages. These stages, which are indicated in FIG. 5, are called a pre-preparation stage, a preparation stage, an execution stage and a completion stage of the handover (HO). Thereby, the categorization illustrated in FIG. 5 is only one possibility to perform the categorization. Similarly, the tasks performed in the described HO may be distributed in a slightly different manner to the various stages.

In the telecommunication network with a relay extension, the network elements that may be part of the HO procedure include a UE, a source RN, a source BS, a target BS, a target RN, a mobility management entity (MME) and a serving gateway (Gtwy). The UE may be any type of communication end device, which is capable of connecting with an arbitrary telecommunication network access point such as a base station or a relay node. In particular the UE may be a cellular mobile phone, a Personal Digital Assistant (PDA), a notebook computer and/or any other movable communication device. The BS may be for instance an evolved node B as in E-UTRAN. The BS can communicate with other network elements such as other BSs or RNs via an air interface or via a wired interface. The communication connection between different BSs is called an X2 interface in the specifications for E-UTRAN. The communication between different BSs can occur also through the S1 interface which connects both the BSs with the serving gateway and thereby indirectly with each other.

In the categorization used in FIG. 5 the pre-preparation stage and the preparation stage include operations related to the initiation of the handover for the UE. The network elements included in this stage are the UE, the source RN and the source BS. Functionalities relating to the realization of the HO for the UE are handled in the execution stage. The network elements that take part in the execution stage may include the target BS and the target RN in addition to the elements in the pre-preparation and the preparation stage. In the completion stage, the network elements included in this stage are the source RN, the source BS, the target BS, the target RN, the MME and the serving gateway (Serving Gtwy). The completion stage handles operations related to, e.g., releasing of the resources and finalizing the HO procedure for the UE.

In cellular telecommunication networks, the UEs may be mobile terminals, which are moving in space. Moving terminals may introduce additional requirements for the system. Connections may be set up on demand and after they are not needed, the resources may be released. As a UE may be transferred to another cell due to its movement, the serving network elements (BS and, if applicable RN) may exchange information regarding the movement of the respective UE. The mobility management entity (MME) handles such exchanges of information between the involved network elements together with a radio resource control (RRC) layer. The MME may take care of, e.g., the preparation of resources at the target BS, allocation of the UE to new radio resources, non-access signaling, tracking area list management, roaming, authentication and releasing resources from the source BS. In other words, the MME serves as an anchoring point for mobile UE connections. Furthermore, the BSs may be logically connected to the MME. The interface between the BSs and the MME is known as an S1 interface in the specifications for E-UTRAN. The MME 110 is, in LTE, part of the evolved packet core (EPC).

The serving gateway may be comprised in a service architecture such as the evolved packet system (EPS) in the LTE. The EPS is, in the LTE, part of the EPC. The serving gateway comprises functions, e.g., to switch the user plane for support of the mobility of the UE, to terminate the user plane packets for paging reasons and route and forward packets. The serving gateway may be connected to an external MME or both of them may be physically collocated.

The signaling during the handover procedure may occur on the Radio Resource Control (RRC) layer. However, there is information that may be exchanged on the physical radio interface (PHY) layer or on the medium access control (MAC) layer. Examples of this information exchange include the transmission of an uplink (UL)/downlink (DL) allocation and synchronization signaling as well as the user data.

In the pre-preparation stage the source RN sends to the UE a message “Msmt Ctrl” 502, which triggers the UE to perform measurements of the RSRP. If applicable, a data packet transfer 504 between the UE and the Serving Gateway is carried out with three hops, a first hop between the UE and the source RN, a second hop between the source RN and the source BS and a third hop between the source BS and the Serving Gateway. Reference numeral 506 indicates an UL allocation message from the source RN to the UE in order to allocate the uplink resources for the communication from the UE to the source RN. The UL allocation message 506 may be transmitted on the PHY layer.

The UE may be triggered to transmit measurement reports 508 to the source RN and, if applicable further to the source BS. The measurement reports 508 may contain information regarding the current serving cell and the adjacent cells to the current serving cell. It may further comprise the status of certain parameters. The parameters that may be measured may include, but are not limited to, at least one of the following: reference signal received power (RSRP), received signal strength and carrier-to-interference ratio (CIR) at the serving cell as well as at the adjacent neighbouring cells.

The source RN performs a HO prediction 510 based on the measurement reports 508 that it has received from the UE. When the CT threshold has been passed for a duration of TTC it assumes a HO is going to happen soon. It communicates this to the source BS by sending a caching request message 512. In this message 512, the source RN will provide which UEs data packets have to be cached. Since one UE can have several GPRS Tunneling Protocol (GTP) tunnels active at the same time, the source RN might have to communicate the GTP tunnel ID of each active bearer of the UE, instead of just the UE ID. Also, an optional timer can be specified by the caching request message 512 to indicate the maximum time this caching is to be active. Apart from this timer, the source RN can also send an explicit command to stop the caching at the source BS. The combination of the caching timer and explicit timer will make sure that there will not be long periods of unnecessary caching in cases of “false alarms” for HO prediction, i.e. where the CT threshold is kept for a long time without the HO threshold being reached. It is noted that in FIG. 5 it is assumed that for the sake of clarity there is not such a false alarm and a handover occurs later on.

Thus, after the reception of the caching request message 512, the source BS will cache the data packets that it is forwarding to the source RN until a HO command is issued to the UE, until the caching timer expires, or until an explicit stop caching command is received. As described above, the source BS can decide how much data packets to buffer either based on a packet discard timer (i.e. how long a packet could stay in its cache), depending on the cache size allocated per UE or bearer or a combination of both.

Later on, if indeed a HO is going to happen (i.e. the HO threshold has been passed for a TTT duration), the source RN performs the HO initiation 520, which according to the categorization used here belongs to the preparation stage following the pre-preparation stage. The RN communicates this to the source BS using a HO request message 522. The HO request message 522 may comprise a request to perform the HO for the UE as well as information about the source and the target cells of the HO. The transmission of the HO request message 522 may be controlled on the RRC layer and, hence, the source RN may comprise such a layer in addition to the MAC layer and the PHY layer. With the transmission of the HO request message 522 the preparation stage is finished. In this respect it is again mentioned that the used categorization is artificial and the performed tasks may also be assigned differently to the various stages.

After the preparation stage the HO execution stage follows. As can be seen from FIG. 5, the execution stage comprises a HO decision 540. The HO decision 540 itself comprises or causes a HO request message 542, which is sent from the source BS to the target BS. The HO request message 542 may be the same as the HO request message 522, or it may be that the source BS processes the HO request message 522 and transmits another HO request message 542 to the target BS. The HO request message 542 may include necessary information related to the HO. The necessary information may include, e.g. radio resource control information such as allocation information of the UE, the source cell identification information and the evolved packet system bearer quality of service information.

The target RN, on the other hand, may conduct an admission control 544 for the relayed communication link between the UE and target RN after it has been determined that the UE is to be handed over. The admission control 544 may be based on the available resources at the target RN that can be granted to the UE. That is, the target RN allocates the required resources for the relayed link connection, wherein the allocation of the link relates to an establishment of a communication link for the UE. As the admission control 544 is partly handed over to the target RN connected to the target BS via the X2-interface, the target BS can apply its resources to other tasks. The target BS may still be responsible for the admission control of the backhaul link between the target RN and a controller of the target RN. Alternative solutions could be (a) that the target RN is responsible for the admission control not only on the relayed link but also on the backhaul link or (b) that the target BS is responsible for the admission control not only on the backhaul link but also on the relayed link.

Then, a HO request message 546 is transmitted from the target BS to the target RN. The target RN, on the other hand, may conduct an admission control 548 for the relayed communication link between the UE and the target RN after it has been determined that the UE is to be handed over. The admission control 548 may be based on the available resources at the target RN that can be granted to the UE. That is, the target RN allocates the required resources for the relayed link connection, wherein the allocation of the link relates to an establishment of a communication link for the UE. As the admission control 548 may be partly handed over to the target RN connected to the target BS via the SX interface, the target BS can apply its resources to other tasks. The target BS may still be responsible for the admission control of the backhaul link between the target BS and the controller of the target BS.

Once the admission control 548 is performed and available resources are allocated to the UE, a HO request acknowledge message 550 may be sent to the target BS and further to the source BS. The HO request acknowledge message 550 may contain, e.g. the security identifiers of the target RN, the possible modifications such as changes in the allocation of other UEs and a confirmation that it is allowed to proceed further with the HO for the UE.

Further, as can be seen from FIG. 5, the source BS transmits an HO command message 552 to the source RN based on the information received from the HO request acknowledge message 550. The HO command message 552 may contain the same data as the HO request acknowledge message 550 and it may further include instructions for the source RN or the UE related to the HO of the UE.

Then, the source RN transmits a DL allocation message 554 to the UE possibly on the PHY layer. The DL allocation message 554 contains information about the downlink channel from which the UE can expect to receive information. The DL allocation message 554 is followed by a transmission of a HO command message 556 from the source RN to the UE.

After receiving the HO command message 556 a procedure 560 starts, in which the UE is detached from the old source cell and a synchronization with the new target cell is performed. The procedure 560 comprises a communicating by the source RN the status of its buffer for the concerned UE to the source BS using a UE delivery status report 562. The UE delivery status report 562 can be either cumulative or selective ACK information, or any other approach as discussed above in the general description of the invention.

The source BS will then use the UE delivery status report 562 to find out which data packets in its cache should be forwarded to the target RN. The source BS will also forward any buffered data that is destined for the concerned UE but not yet forwarded to the source RN, and from this moment onwards will stop forwarding data to the source RN.

In order to provide for an effective data transfer also in the uplink direction of the handed over UE, a Sequence Number (SN) status transfer message 564 is transmitted from the source BS to the target BS and further from the target BS to the target RN, indicated with reference numeral 566. This message may be used in order to transfer important status information that has been acquired when the packet transmission at the source side is terminated because the UE is moving from the source side to the target side. In this respect it is mentioned that a transmission of the SN status transfer message 564 from the source BS to the target BS is already known. However, the transmission of the SN status transfer message 564 from target BS to the target RN allows for providing the status information also to the target RN.

Thereafter, the DL data packets which have been cached and buffered by the source BS, are forwarded from the source BS to the target BS and further to the target RN. This is indicated in FIG. 5 with reference numerals 570, 572 and 574. Upon the reception of the respective data packets they are buffered by the target BS. This buffering is indicated with reference numeral 575.

In the following the execution stage is completed by the UE by accomplishing a synchronization 576 with the target cell of the HO. After the synchronization 576 of the UE and the target RN has been performed, an UL allocation message 577 is transmitted on the PHY or MAC layer from the target RN to the UE. The UL allocation message 577 contains information about the uplink channel from which the target RN may expect to receive data from the UE. The target RN may further transmit timing information to the UE, in which the UE obtains the latency information (Timing Advance) regarding the transmission between the UE and the target RN. In other words, the UE may use the timing information to advance or delay its timings of transmissions to the target RN or to the target BS and, thus, compensate for a propagation delay.

The UE uses the UL allocation message 577 to transmit an HO confirmation message 578 to the target RN. The HO confirmation message 578 may contain information regarding the success of the HO procedure with respect to the UE. This may optionally be followed by the transmission of a HO confirmation message 579 from the target RN to the target BS controlling the target RN. With the transmission of the HO confirmation messages 578 and 579 the execution stage is completed.

According to the selected categorization used for FIG. 5 the HO completion stage begins with a HO completion message 580 to the MME. The HO completion message 580 may include data to inform the MME that the HO for the UE has been successfully executed. The HO completion message 580 may further comprise for instance a triggering function to set up the resources for the new connection links. The acknowledgement of the links, the reorganization of the resources, packet routing and forwarding, and signaling to the other nodes of the communication network to inform of the change of the resources and the HO may be conducted at the MME and at the serving gateway.

Then, the MME sends a user plan update request message 582 to the serving gateway. The user plan update message 582 may include instructions to switch the DL path 584 in the serving gateway to ensure that all arriving data packets for the UE will from now on be routed to the correct BS. Further, the serving gateway is triggered to transmit a user plan update acknowledgment message 586 to the MME, which in response transmits a HO complete acknowledgement message 588 to the target BS informing the target BS that the resource allocations regarding the HO procedure were successful.

After the new connection link has been established, the old connection between the source BS and the source RN may be released. This can be performed by sending a release resources message 590 to the source BS which transmits a subsequent release resources message 591 to the source RN. From this message the source RN knows that it can release the resources allocated to the UE. At the same time the buffer of the source BS is flushed and in transit data packets are delivered as usual. This is indicated with reference numeral 592.

The successful release of the resource associated with the source RN is indicated in FIG. 5 by reference numeral 593. In addition, remaining DL data are forwarded from the source BS to the target BS (see reference numeral 594) and further from the target BS to the target RN (see reference numeral 595). After forwarding the DL data from the source BS to the target BS resources being associated with the source BS can be released. This is indicated with reference numeral 596. From now on data packets, which have to be transmitted to the UE are forwarded from the serving gateway to the target BS (see reference numeral 597), from the target BS to the target RN (see reference numeral 598) and from the target RN to the UE (see reference numeral 599).

In the following some further aspects and advantages, which are related to the described caching of DL data packets at the source BS are discussed:

(1) Data packet caching can also be realized in a simplified way by limiting the RN buffer size to a very small amount, and performing most of the buffering at the mother BS. Thus, the BS will implicitly be performing the caching and the amount of data that has to be back-forwarded from the source RN to the source BS can be greatly reduced due to the small number of pending packets in the source RN's buffer. This might work properly in a telecommunication network where there are very few RNs and it can be combined with the caching idea presented so far in this document. For example, the signal flow illustrated in FIG. 5 can be adapted to this by removing the cache initiation process, but still keeping the “UE delivery status” reporting. Though it is very simple to implement, the problem with this method is that it might not be optimal, especially when it comes to decentralized scheduling. With a limited buffering, the source RN will be very dependent on the serving source BS for its scheduling, and as such, might not be able to take advantage of instantaneous favorable conditions on the radio link extending between the source RN and the UE as it might not have enough data to send out.

(2) The mechanism to cache packets destined to the UE at the RN for optimal handover as described in this document is completely transparent to the UEs, and as such also 3GPP Release 8 UEs will benefit from it. However changes are required in the RN and BS respectively the eNB.

(3) The use of caching will reduce the amount of back-forwarded traffic in the telecommunication network during HO and as such will decrease the possible load spikes during HO on the backhaul link in uplink, especially if there are several RNs per cell (which is a realistic scenario). Not only that, the possibility of out of order data packet delivery due to the forwarding of old data packets from the source RN and new data packets arriving at the target RN is avoided. Moreover, the delay for forwarding packets to the target BS is reduced. For a handover from a RN to the mother BS the data communication can start immediately, because in this case the data are already present at the mother BS.

(4) In order to perform the cumulative or selective Acknowledgement (see Sol_{—}1 presented in the general description of the invention), the RN has to make a mapping between the Radio Link Control (RLC) service data units (SDUs) in the backhaul and access links. As an example, two RLC SDUs, SDUa and SDUb, are assumed to be are sent from the BS to the RN. These SDUs might end up being forwarded to the UE by the RN as three SDUs: SDU1 (containing only parts of SDUa), SDU2 (containing the remaining of SDUa and some part of SDUb) and SDU3 (remaining parts of SDUb). Thus, additional bookkeeping functionality has to be introduced in the RN that will keep track of these mappings in order to send meaningful ACKs/SACKs to the BS telling it which packets to forward to the target BS respectively to the target RN.

(5) For some real-time services, such as interactive video conferencing, forwarding during a HO can in general be a bad idea. This may even hold with the HO optimization described in this document, because the extra delay introduced by the forwarding might desynchronize the two communicating parties. Thus, in these cases, it might be preferred to delete all the data at the source RN when handover starts.

A scheme where the caching/buffering can be set on a bearer basis should thus be a more flexible approach. As a further refinement it is possibly to only cache/forward the newest i.e. youngest data packets, because they have the greatest chance to be still delivered in time after the handover process but drop i.e. delete older packets.

(6) The caching/forwarding scheme described in this document can further be complemented by using bi-casting as is done in older systems such as GSM that support only hard handover. That is, when a HO is started, the BS bi-casts the data packets to the source RN as well as to the target RN via the target BS. And until the HO is finalized, the UE will get the data packets from the source RN. After the HO is finalized, the target RN will be able to find out which data packets have already been received by the UE (using cumulative ACKs, for example, or an information on the set of already transmitted data packages which can be communicated from the source RN to the target RN similarly to the SN status transfer message), and thus does not have to forward redundant data.

This may be especially beneficial for real time services with the stringiest delay requirements as it will cause minimal interruption time. For non-real time services, bi-casting might not be as beneficial and as such could be performed only when the load situation in the system allows it, for example between RNs within the same cell and when the relay link is experiencing very good radio conditions (e.g. when there is a Line Of Sight between the RN and its mother BS).

Bi-casting may be possible without impacting the capacity if the target RN can listen to the data packets that are transmitted to the source RN as well. However it may be beneficial in this case to code the bi-casted data specifically to avoid that the target RN has to decode all the data for the source RN.

Furthermore, the transmission towards the target RN can be done in a best effort manner, i.e. no ACK/NACK is sent from the target RN to the BS immediately. Only after the HO is finalized, the missing data packets will be communicated to the BS. In this way the retransmission of data packets from the source BS to the target RN can be avoided for data packets, which have already been transmitted from the RN to the UE. In this case, the pre-forwarding to the target RN is unnecessary (but does not cost capacity) but a Hybrid Automated Repeat Request (HARQ) is both unnecessary and also costs capacity, so it is more important to avoid the later than the former.

A HO can always fail (more specifically the connection establishment at the target RN), and in this case the UE connects back to the source RN. Therefore, the bi-casting can be continued until the HO is confirmed in order to prevent that data packets which have already been forwarded to the target RN need to be back-forwarded again to the source RN.

Last but not least it should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

### LIST OF REFERENCE SIGNS

FIGS. 1a/1b:

BS base station

BS1 source base station

BS2 target base station

RN1 source relay node

RN2 target relay node

SX SX interface

UE user equipment

X2 X2 interface

FIGS. 2a, 2b, 2c, 2d:

BS1* source base station

BS2 target base station

NE transmitting network element

RN1 source relay node

RN2 target relay node

UE user equipment (before handover)

UE′ user equipment (after handover)

FIGS. 3a, 3b, 3c, 3d:

BS1 source base station

BS2* target base station

NE receiving network element

RN1 source relay node

RN2 target relay node

UE user equipment (before handover)

UE′ user equipment (after handover)

FIG. 4:

a, b time points for time to cache

c, d time points for time to trigger

CT caching threshold

RSRP reference signal received power

TTC time to cache

TTT time to trigger

FIG. 5:

BS base station

Gtwy gateway

MME mobility management entity

RN relay node

UE user equipment

502 measurement control message

504 data packet transfer

506 UL allocation message

508 measurement reports

510 handover (HO) prediction

512 caching request

514 data packet caching

520 HO initiation

522 HO request message

540 HO decision

542 HO request message

544 admission control (Backhaul)

546 HO request message

548 admission control (Access)

550 HO request acknowledge message

552 HO command message

554 DL allocation message

556 HO command message

560 procedure for detaching UE from the source cell and synchronizing UE with the target cell

562 UE delivery status report

564 Sequence Number (SN) status transfer message

566 SN status transfer message

570 Deliver cached and buffered data packets to target BS

572 DL data forwarding

574 DL data forwarding

575 data packet buffering

576 synchronization

577 UL allocation message

578 HO confirmation message

579 HO confirmation message

580 HO complete message

582 user plan update request message

584 DL path switch

586 user plan update acknowledgment message

588 HO complete acknowledgement message

590 release resources message

591 release resources message

592 flush buffer of source BS

593 resource release at source RN

594 DL data forwarding

595 DL data forwarding

596 resource release at source BS

597 data packet forwarding

598 data packet forwarding

599 data packet forwarding

1. A method for transferring data within a telecommunication network in a downlink direction from a transmitting network element to a user equipment, the method comprising sending at least one data packet from the transmitting network element to a source base station,
receiving the data packet by the source base station, which is connected to a source relay node rep-resenting a source access point for the user equipment,
caching the data packet by the source base station,
handing over the user equipment from the source relay node to a target access point, and
transferring the cached data packet from the source base station via the target access point to the user equipment.

2. The method as set forth in claim 1, wherein the target access point is a target relay node, which is connected to a target base station or to the source base station.

3. The method as set forth in claim 1, wherein the target access point is a target base station or the source base station.

4. The method as set forth in claim 1, further comprising
selecting the at least one data packet from a plurality of data packets based on a Quality of Service being assigned to the data packet.

5. The method as set forth in claim 1, wherein caching the data packet by the source base station is only started if a predefined trigger criterion is met.

6. The method as set forth in claim 1, wherein caching the data packet by the source base station is only started if the predefined trigger criterion is met for a predefined amount of time.

7. The method as set forth in claim 5, wherein caching the data packet by the source base station is terminated at least temporarily if the trigger criterion is no more met.

8. The method as set forth in claim 1, wherein a plurality of data packets are cached by the source base station and the source base station carries out a flow control for caching the plurality of data packets.

9. A method for transferring data within a telecommunication network in an uplink direction from a user equipment to a receiving network element, the method comprising sending at least one data packet from the user equipment to a source access point,
handing over the user equipment from the source access point to a target relay node representing a target access point for the user equipment and being connected to a target base station,
receiving the at least one data packet by the target base station,
caching the received data packet by the target base station, and
transferring the cached data packet from the target base station to the receiving network element.

10. The method as set forth in claim 9, wherein the source access point is a source relay node, which is connected to a source base station or to the target base station.

11. The method as set forth in claim 9, wherein the source access point is a source base station or the target base station.

12. The method as set forth in claim 9, further comprising
combining at the target base station the at least one data packet, which has been received by the target base station via the source base station from the user equipment before the handover of the user equipment and which has been cached by the target base station with at least a further data packet, which has been received by the target base station via the target relay node after the handover, wherein transferring the data packet from the target base station to the receiving network element comprises transferring the combined data packets from the target base station to the receiving network element.

13. A source network element from the set of a source base station and a source relay node, which in co-operation with at least the other source network element from that set and a user equipment is adapted to carry out the method as set forth in claim 1 for transferring data within a telecommunication network in a downlink direction from a transmitting network element to the user equipment.

14. A target side network element from the set of a target base station and a target relay node, which in co-operation with at least the other target network element from that set and a user equipment is adapted to carry out the method as set forth in claim 9 for transferring data within a telecommunication network in an uplink direction from the user equipment to a receiving network element.

15. A computer program for transferring data within a telecommunication network, the computer program, when being executed by a data processor of a network element, is adapted for controlling the method as set forth in claim 1 for transferring data within the telecommunication network in a downlink direction from a transmitting network element to a user equipment or for controlling the method for transferring data within a telecommunication network in an uplink direction from a user equipment to a receiving network element, the method comprising
sending at least one data packet from the user equipment to a source access point,
handing over the user equipment from the source access point to a target relay node representing a target access point for the user equipment and being connected to a target base station,
receiving the at least one data packet by the target base station,
caching the received data packet by the target base station, and transferring the cached data packet from the target base station to the receiving network element.
